(19) United States
(12) Patent Application Publication
(10) Pub. No.: US 2024/0197021 A1
(43) Pub. Date: Jun. 20, 2024

(54) PORTABLE SMART AIR HELMET

(71) Applicant: Sang Kyung KIM, Chungcheongbuk-do (KR)

(72) Inventors: Sang Kyung KIM, Chungcheongbuk-do (KR); Mi Soon OH, Chungcheongbuk-do (KR)

(21) Appl. No.: 18/290,207

(22) PCT Filed: Apr. 27, 2022
(86) PCT No.: PCT/KR2022/006057

§ 371 Date: Nov. 10, 2023

(30) Foreign Application Priority Data
Apr. 29, 2021 (KR) 10-2021-0055447

(51) Int. Cl. A42B 3/04; A42B 3/12; A42B 3/32; G08B 21/02

(52) U.S. Cl. CPC A42B 3/046; A42B 3/122; A42B 3/322; G08B 21/0269

(57) ABSTRACT

Disclosed is a portable smart air helmet including a head protection member including tubes configured to be expanded and provide an elastic force when air is injected into the tubes, and configured to be contracted and foldable when the injected air is discharged, an electric air pump configured to inject air into the head protection member or discharge the air injected into the head protection member, an accident notification device installed on the head protection member and the pouch and configured to automatically transfer information on an impact when the impact is applied to the head protection member and the pouch, and a pouch configured to enable a user to carry the electric air pump and the head protection member from which air is discharged.

### TECHNICAL FIELD

The present disclosure relates to a portable smart air helmet.

### BACKGROUND

This section provides background information related to the present disclosure which is not necessarily prior art.

Helmets are manufactured by using various materials. Because a helmet in the related art has a predetermined fixed shape, there is a problem in that it is difficult to carry and store the helmet, and a significant weight is applied to a user when the user wears the helmet over a long period of time even though the helmet is made of a lightweight material.

Because of this problem, the users do not properly wear helmets when using bicycles, in-line skates, motorized wheels, motorized kickboards, and the like although the helmets are mandatory.

Meanwhile, recently, air helmets using air have been developed in order to solve the above-mentioned problems. The air helmet is expanded by injected air to a shape that allows the user to wear the air helmet on the user's head when the user uses the air helmet, and the air helmet is contracted by discharging the injected air when the user does not use the air helmet.

The air helmets in the related art are advantageously carried and stored because the shapes thereof are contracted. However, there is a problem in that children easily lose the air helmets contracted in shape.

In addition, the air helmets in the related art are cumbersome to use because the air helmets require the users to inject air by blowing air directly into the air helmets by using their mouths and require the users to directly discharge the injected air.

Further, the air helmets in the related art have another problem in that guardians cannot recognize the fact that impact is applied to the head of wearers, particularly infants and children.

Accordingly, the inventors of the present application have made an effort to solve a problem of air helmets in the related art, and as a result, the present disclosure is filed for a patent application.

### DISCLOSURE

### Technical Problem

An object of the present disclosure is to provide a portable smart air helmet having a head protection member that may be contracted in shape so as to be stored.

Another object of the present disclosure is to provide a portable smart air helmet having a head protection member into or from which air may be injected or discharged by electric power.

Still another object of the present disclosure is to provide a portable smart air helmet capable of notifying a guardian or an adjacent administrative agency such as a fire department that impact is applied to a wearer's head.

### Technical Solution

This section provides a general summary of the disclosure and is not a comprehensive disclosure of its full scope or all of its features.

One aspect of the present disclosure provides a portable smart air helmet including: a head protection member including tubes configured to be expanded and provide an elastic force when air is injected into the tubes, and configured to be contracted and foldable when the injected air is discharged; an electric air pump configured to inject air into the head protection member or discharge the air injected into the head protection member; a pouch configured to enable a user to carry the electric air pump and the head protection member from which air is discharged; and an accident notification device installed on the head protection member and the pouch and configured to automatically transfer information on an impact when the impact is applied to the head protection member and the pouch.

In the portable smart air helmet according to the aspect of the present disclosure, the pouch may include: a pouch main body configured to define an accommodation space configured to accommodate therein the electric air pump, the accident notification device, and the head protection member from which air is discharged; and a locking means configured to open or close the accommodation space, and a snap ring may be mounted at one side of the pouch main body.

In the portable smart air helmet according to the aspect of the present disclosure, the head protection member may include: a plurality of impact detection rods in which impact detectors and GPS sensors of the accident notification device are embedded; and a band configured to fix the head protection member to the user's head, an air injection/discharge port may be provided at one side of the tube, and upper and lower ends of the impact detection rods may be fixed and welded to the tubes so that internal spaces defined by the tubes are connected vertically.

In the portable smart air helmet according to the aspect of the present disclosure, the electric air pump may be connected to the air injection/discharge port by means of a connection hose and inject or discharge air.

In the portable smart air helmet according to the aspect of the present disclosure, the accident notification device may include: impact detectors installed on the head protection member and the pouch; GPS sensors installed on the head protection member and the pouch; and a controller connected to a power source of the electric air pump and a separately provided power source and configured to transfer information on the presence or absence of an accident and an accident point to a terminal of a pre-registered guardian, an information server of a retailer, which has provided the portable smart air helmet, or a control center of an administrative agency on the basis of signals outputted from the impact detector and the GPS sensor.

In the portable smart air helmet according to the aspect of the present disclosure, the controller may include: a first information processor electrically connected to the impact detector in a wired or wireless manner and configured to determine the presence or absence of an accident on the basis of a signal outputted from the impact detector; a second information processor electrically connected to the GPS sensor in a wired or wireless manner and configured to determine the accident point on the basis of a signal outputted from the GPS sensor; a memory configured to store information on the terminal of the guardian or the control center of the administrative agency to which an accident signal is to be transmitted; and a communication module configured to transmit an accident occurrence signal and an accident point to the terminal of the pre-registered the guardian, the information server of the retailer, or the control center of the administrative agency when an accident is determined by the first information processor.

### Advantageous Effects

According to the present disclosure, the pouch into which the head protection member contracted in shape may be inserted and stored may be provided, thereby preventing the head protection member contracted in shape from being lost.

According to the present disclosure, the electric air pump may be embedded in the pouch, thereby easily injecting or discharging air into or from the head protection member.

According to the present disclosure, when an impact is applied to the head protection member and the pouch, the guardian, the information server of the retailer, which has provided the portable smart air helmet according to the present disclosure, or the adjacent administrative agency may recognize the impact. Therefore, it is possible to quickly cope with the occurrence of an accident and prevent the impact from leading to a serious accident.

### BRIEF DESCRIPTION OF DRAWINGS

FIG. 1 is a view schematically illustrating a portable smart air helmet according to the present disclosure.

FIG. 2 is a view schematically illustrating a state in which a user wears the air helmet illustrated in FIG. 1.

FIG. 3 is a configuration view schematically illustrating an accident notification device illustrated in FIG. 1.

### MODES OF THE INVENTION

Hereinafter, embodiments for implementing a portable smart air helmet according to the present disclosure will be described in detail with reference to the drawings.

However, it should be noted that the intrinsic technical spirit of the present disclosure is not limited by the following exemplary embodiment, and the following exemplary embodiment may easily be substituted or altered by those skilled in the art based on the intrinsic technical spirit of the present disclosure.

In addition, the terms used herein are selected for convenience of description and should be appropriately interpreted as a meaning that conform to the technical spirit of the present disclosure without being limited to a dictionary meaning when recognizing the intrinsic technical spirit of the present disclosure.

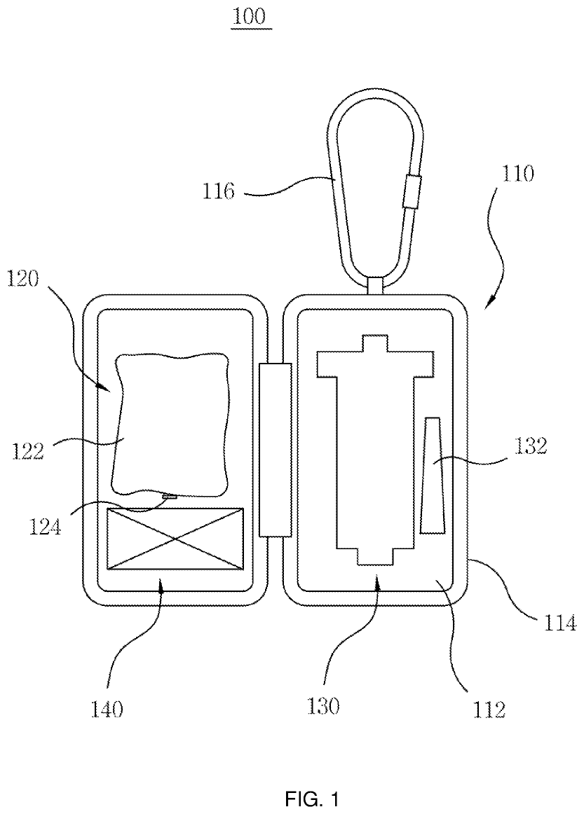

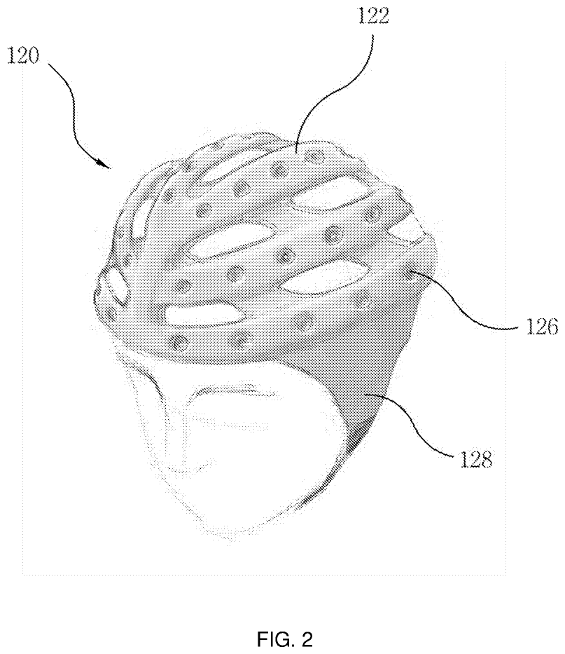

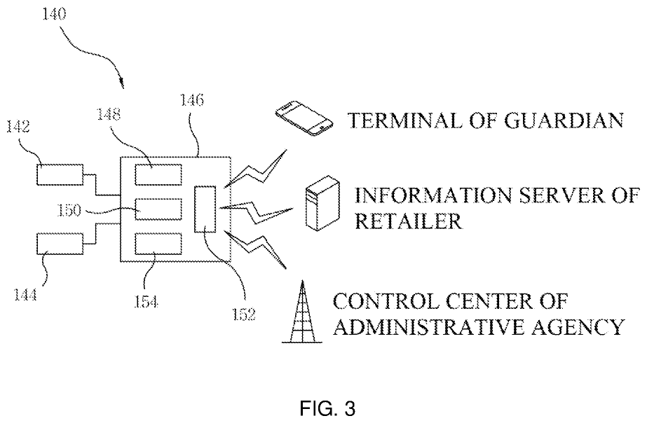

Among the attached drawings, FIGS. 1 to 3 are views schematically illustrating a portable smart air helmet according to the present disclosure.

With reference to FIGS. 1 to 3, a portable smart air helmet 100 according to the present disclosure includes a head protection member 120, an electric air pump 130, an accident notification device 140, and a pouch 110.

First, the pouch 110 enables a user to carry the head protection member 120, which is contracted and folded, the electric air pump 130, and the accident notification device 140.

To this end, the pouch 110 includes a pouch main body 112 having an accommodation space therein, and a locking means 114 configured to open or close the accommodation space.

In this case, the locking means 114 may be provided as a typical zipper. The locking means 114 is mounted on the pouch main body 112 so that the accommodation space is unfolded flat when the accommodation space is opened.

Meanwhile, a snap ring 116 is mounted at one side of the pouch main body 112 to improve convenience in carrying the portable smart air helmet 100 according to the present disclosure.

In this case, a shape of the snap ring 116 is not specially limited. The snap ring 116 may be provided as a typical karabiner or the like.

Particularly, the pouch main body 112 may be made of leather, synthetic leather, fiber, synthetic resin, and the like.

The head protection member 120 is configured to be worn on the user's head and protect the user's head from impact.

The head protection member 120 includes typical tubes 122 configured to be expanded and provide an elastic force when air is injected into the tubes 122, and configured to be contracted and foldable when the injected air is discharged.

In this case, an air injection/discharge port 124 is formed at one side of the tube 122 to allow air to be injected into the tube 122 or allow the air injected into the tube 122 to be discharged.

That is, when air is injected into the tube 122 through the air injection/discharge port 124, the head protection member 120 is expanded to an approximately hemispherical dome shape so that the user may wear the helmet on the user's head. The head protection member 120 is expanded to surround and protect the frontal, parietal, occipital, and bilateral temporal regions of the user.

On the contrary, the head protection member 120 is contracted and foldable when the air in the tube 122 is discharged through the air injection/discharge port 124.

In this case, because the process of injecting and discharging air through the single air injection/discharge port 124 is a publicly-known technology, a detailed description thereof will be omitted.

Meanwhile, as illustrated, the head protection member 120 includes impact detection rods 126 and bands 128.

Upper and lower ends of the impact detection rods 126 are fixed and welded to the tubes 122 so that internal spaces defined by the tubes 122 are connected vertically.

The impact detection rods 126, which are fixed to the tubes 122 as described above, are uniformly provided over all the tubes 122 so as to be spaced apart from one another at predetermined intervals. An impact detector 142 and a GPS sensor 144 of the accident notification device 140 to be described below may be embedded in each of the impact detection rods 126.

Further, the bands 128 serve to fix the head protection member 120 to the user's head. In the present disclosure, the band 128 is not specially limited.

That is, the band 130 may have any shape as long as the band 130 may fix the expanded head protection member 120 to the user's head.

For example, the bands 128 may include fixing straps extending from two opposite sides of the head protection member 120, and a buckle (not illustrated) configured to connect extension ends of the fixing straps 129.

The electric air pump 130 injects air into the head protection member 120 or discharges the air injected into the head protection member 120.

As illustrated in FIG. 1, the electric air pump 130 may be disposed in the accommodation space defined by the pouch main body 112.

In this case, in order to improve carrying convenience, the electric air pump 130 uses a typical coin battery, a typical primary battery, or a typical secondary battery, which may be repeatedly charged and discharged, as a power source.

Further, the electric air pump 130 is connected to the air injection/discharge port 124 by means of a connection hose 132 at the time of injecting or discharging air into or from the head protection member 120.

In this case, because the configuration of the electric air pump 130 and the injection and discharge of air implemented by the operation of the electric air pump 130 are publicly-known technologies, detailed descriptions thereof will be omitted.

When an impact is applied to the head protection member 120 and the pouch 110 in the state in which the user wears the head protection member 120, the accident notification device 140 automatically transfer information on the impact to a terminal of a pre-registered guardian, an information server of a retailer that has provided the portable smart air helmet 100 according to the present disclosure, or a control center of an administrative agency, particularly a 119 control center.

The accident notification device 140 includes the impact detectors 142 and the GPS sensors 144 installed on the head protection member 120 and the pouch 110, and a controller 146 configured to transfer, on the basis of signals outputted from the impact detector 142 and the GPS sensor 144, information on the presence or absence of an accident and an accident point to the terminal of the pre-registered guardian, the information server of the retailer that has provided the portable smart air helmet 100 according to the present disclosure, or the control center of the administrative agency.

In this case, the impact detector 142 is provided as a typical gyro sensor or a typical impact sensor. Because the GPS sensor 144 is a publicly-known technology, a detailed description thereof will be omitted.

In this case, the impact detector 142 and the GPS sensor 144 installed on the head protection member 120 may be embedded in each of the impact detection rods 126 of the head protection member 120, as described above.

Meanwhile, the controller 146 is installed in the head protection member 120 or the pouch 110 and connected to a power source of the electric air pump 130 or a separately provided power source in a wired or wireless manner.

The controller 146 includes a first information processor 148 electrically connected to the impact detector 142 in a wired or wireless manner and configured to determine the presence or absence of an accident on the basis of a signal outputted from the impact detector 142, and a second information processor 150 electrically connected to the GPS sensor 144 in a wired or wireless manner and configured to determine the accident point on the basis of a signal outputted from the GPS sensor 144.

In addition, the controller 146 further includes a memory 154 configured to store information on the terminal of the guardian or the control center of the administrative agency to which an accident signal is to be transmitted, and a communication module 152 configured to transmit an accident occurrence signal and an accident point to the terminal of the pre-registered guardian, the information server of the retailer that has provided the portable smart air helmet 100 according to the present disclosure, or the control center of the administrative agency when an accident is determined by the first information processor 148.

That is, when the signal outputted from the impact detector 142 installed on the head protection member 120 and the pouch 110 exceeds a preset amount of impact or exceeds a preset amount of change in azimuth, the first information processor 148 determines this situation as an accident and outputs an accident signal.

Further, when the accident signal is outputted from the first information processor 148, the controller 146 processes the accident signal outputted from the first information processor 148 and accident point position information outputted from the second information processor 150 and automatically transfers, through the communication module 152, the processed information to the terminal of the guardian, the information server of the retailer that has provided the portable smart air helmet 100 according to the present disclosure, or the control center of the administrative agency, particularly a local 119 control center, which is stored in the memory 154.

In this case, the information server of the retailer, which has provided the portable smart air helmet 100 according to the present disclosure, stores user information, the usage history of the portable smart air helmet 100 according to the present disclosure, and the signals outputted from the impact detector 142 and the GPS sensor 144 installed on the head protection member 120 and the pouch 110.

In particular, the information server of the retailer stores all the signals outputted from the impact detector 142. The information server of the retailer statistically analyzes and makes data of the stored signals of the impact detector 142 as habits, risks, and accidents. The information server of the retailer may learn the data to find the user's usage pattern and inform the user of the usage pattern through the application developed by the retailer.

According to the present disclosure described above, the pouch 110 into which the head protection member 120 contracted in shape may be inserted and stored may be provided, thereby preventing the head protection member 120 contracted in shape from being lost.

In addition, according to the present disclosure, the electric air pump 130 may be embedded in the pouch 110, thereby easily injecting or discharging air into or from the head protection member 120.

Furthermore, according to the present disclosure, when an impact is applied to the head protection member 120 and the pouch 110, the guardian, the information server of the retailer, which has provided the portable smart air helmet 100 according to the present disclosure, or the adjacent administrative agency may recognize the impact. Therefore, it is possible to quickly cope with the occurrence of an accident and prevent the impact from leading to a serious accident.

What is claimed is:

1. A portable smart air helmet comprising:
a head protection member including tubes configured to be expanded and provide an elastic force when air is injected into the tubes, and configured to be contracted and foldable when the injected air is discharged;
an electric air pump configured to inject air into the head protection member or discharge the air injected into the head protection member;
a pouch configured to enable a user to carry the electric air pump and the head protection member from which air is discharged; and
an accident notification device installed on the head protection member and the pouch and configured to automatically transfer information on an impact when the impact is applied to the head protection member and the pouch,
wherein the head protection member comprises:
a plurality of impact detection rods in which impact detectors and GPS sensors of the accident notification device are embedded; and
a band configured to fix the head protection member to the user's head,
wherein an air injection/discharge port is provided at one side of the tube, and
wherein upper and lower ends of the impact detection rods are fixed and welded to the tubes so that internal spaces defined by the tubes are connected vertically.

2. The portable smart air helmet of claim 1, wherein the pouch comprises:
a pouch main body configured to define an accommodation space configured to accommodate therein the electric air pump, the accident notification device, and the head protection member from which air is discharged; and
a locking means configured to open or close the accommodation space, and
wherein a snap ring is mounted at one side of the pouch main body.

3. The portable smart air helmet of claim 1, wherein the electric air pump is connected to the air injection/discharge port by means of a connection hose and injects or discharges air.

4. The portable smart air helmet of claim 1, wherein the accident notification device comprises:
impact detectors installed on the head protection member and the pouch;
GPS sensors installed on the head protection member and the pouch; and
a controller connected to a power source of the electric air pump and a separately provided power source and configured to transfer information on the presence or absence of an accident and an accident point to a terminal of a pre-registered guardian, an information server of a retailer, which has provided the portable smart air helmet, or a control center of an administrative agency on the basis of signals outputted from the impact detector and the GPS sensor.

5. The portable smart air helmet of claim 4, wherein the controller comprises:
a first information processor electrically connected to the impact detector in a wired or wireless manner and configured to determine the presence or absence of an accident on the basis of a signal outputted from the impact detector;
a second information processor electrically connected to the GPS sensor in a wired or wireless manner and configured to determine the accident point on the basis of a signal outputted from the GPS sensor;
a memory configured to store information on the terminal of the guardian or the control center of the administrative agency to which an accident signal is to be transmitted; and
a communication module configured to transmit an accident occurrence signal and an accident point to the terminal of the pre-registered the guardian, the information server of the retailer, or the control center of the administrative agency when an accident is determined by the first information processor.
